(19) United States
(12) Patent Application Publication
(10) Pub. No.: US 2007/0060285 A1
(43) Pub. Date: Mar. 15, 2007

(54) SYSTEM AND METHOD OF PLAYING LOTTERY GAMES, BUYING AND PRINTING LOTTERY TICKETS FROM HOME / OFFICE USING SOFTWARE ON COMPUTER

(75) Inventors: David White, Boca Raton, FL (US); Abhishek Kumbhat, Rajasthan (IN)

Correspondence Address: GREENBERG-TRAURIG, 1750 TYSONS BOULEVARD, 12TH FLOOR, MCLEAN, VA, 22102, US

(73) Assignee: LottoSoft Corporation, Boca Raton, FL (US)

(21) Appl. No.: 11/466,735

(22) Filed: Aug. 23, 2006

Related U.S. Application Data
(60) Provisional application No. 60/710,159, filed on Aug. 23, 2005.
(60) Provisional application No. 60/726,705, filed on Oct. 17, 2005.

(51) Int. Cl. G06F 19/00

(52) U.S. Cl. 463/18

(57) ABSTRACT

A system for enabling state lottery game play, wherein a first software module stores player account information and validates state lottery game play purchase information; a second software module runs on a player computing device and facilitates a player authenticating himself with the first software module. The first software module and the second software module communicate only player authentication information, user account information, player lottery game play purchase information, and player registration information, such that the second software module can otherwise operate independently from the first software module. The second software module can also facilitate selection of numbers to be played in a lottery game, and facilitate printing lottery tickets. A third software module receives lottery game play purchase data from the first software module and transmits winning game information to the second software module.

This application claims the benefit of Provisional U.S. Patent Application Ser. No. 60/710,159 filed Aug. 23, 2005, and of Provisional U.S. Patent Application Ser. No. 60/726,705, filed Oct. 17, 2005, the teachings of which are hereby incorporated by reference in their entirety.

### FIELD

The instant disclosure relates to the field of lottery games, and in particular, to systems and methods of providing lottery tickets and related services on the player's demand, at the player's premises, and using software at the player's premises, wherein the software is networked with at least a centralized service provider's office over a secure data communication connection.

### BACKGROUND

Passion to play on chance, and dreams to become a millionaire, have made state lotteries attractive games of chance. Every year, billions of dollars are spent playing state lotteries, and many people try their luck day after day. As a result, there are thousands of retail stores in each state that sell lottery tickets. To obtain a ticket, however, players must physically visit one of these retail stores.

In visiting the retail store, the player receives a lottery slip as per the particular game from the retailer and selects a number or numbers out of the printed numbers on the lottery slip based on the game's rules. In return, after submitting the filled out lottery slip, the player receives from the retailer a ticket with his selected number or numbers printed thereon. The retailer also transfers the relevant information to the state lottery office via an electronic communication setup which is frequently tied to the ticket printing machines.

On the day of the game, one or more winning numbers are drawn for that particular game. If the player's selected numbers match the winning numbers, the player can claim his winnings by presenting the printed ticket to the state lottery office or, in some instances, a participating retailer. The state lottery office or the retailer verifies the claimed ticket and awards any winnings to the ticket's owner.

The prospect of having to visit a retailer each time the player wants to play a lottery game makes playing the game inconvenient and time consuming for many prospective players. Along with this, the presence of a plurality of retailers between players and a state lottery office makes the lottery game process chain longer, thus complicating the overall system.

In today's Internet-based economy, consumers are increasingly accustomed to nearly instantaneous ordering and delivery of goods and services, and especially impulse-purchased goods like books, music, and the like. This makes it frustrating to have to visit a retail store whenever a lottery ticket is desired, especially if the player has no other need to visit the retailer.

What is needed are systems and methods by which a player can avoid visiting a retail store each time he wants to play a state lottery, such as by playing a lottery game via software while at home or at the office. Such systems and methods should allow the games to be frequently updated, refreshed, and replaced. Each play should be initiated and communicated via a secure communication means, thereby facilitating connection with a centralized service provider's office and/or with a state lottery office. The retailer-based model of state lottery game distribution should also be simplified.

The instant disclosure describes new systems and methods of playing games, including state lottery games. Through these disclosed systems and methods, a player can play the lottery by buying and printing lottery tickets at his home/office as frequently as he wishes. Numerous security measures can also be embedded into the system to reduce the likelihood of fraud. The disclosed systems and methods also shorten and simplify the distribution chain for a game by eliminating or reducing the need for retailers in the lottery ticket distribution chain.

### BRIEF DESCRIPTION OF THE DRAWINGS

FIG. 1 is a block diagram illustrating an exemplary lottery system architecture.

FIG. 2 is a flow chart illustrating an exemplary process for performing a state lottery game.

FIG. 3 is a flow chart illustrating an exemplary of playing a lottery game at a player's premises.

### DETAILED DESCRIPTION

The instant disclosure discloses systems and methods of playing lottery games, and more specifically for buying and printing lottery tickets at a player's premises utilizing user friendly software installed on a personal computer, laptop, portable digital assistant (“PDA”), cellular telephone, or other computing device. The disclosed system can be transparent to the players as far as method of playing the games is concerned. The players play the lottery game itself in the same manner as they have in past, with the exception that software running on the computing device presents a user interface to the lottery game. The computing device and software create a secure, convenient, and reliable alternative for players wishing to avoid having to visit a retailer to purchase one or more lottery tickets. The purchasing of tickets can be observed and recorded by software running at a state lottery office and/or at a service provider's office. The disclosed system not only makes it convenient for players to buy lottery tickets while at home, in their office, or any time a computing device with the appropriate software is available, but also shortens and simplifies the process chain of the game.

The systems and methods disclosed herein can provide the following services:
1) Create a player's profile during registration and create his user name and password for accessing his account.
2) Manage player's balance for the game, paid either by credit card or check to a specific account exclusive to the purchase of lottery tickets. The account is managed by the service provider. A record of each transaction and remaining balance on the player's account is sent to the state lottery office and player following each ticket purchase.
3) Play a selected game out of several games offered by state lottery office.
4) Buy and print lottery ticket(s) for the game.
5) Manage database that tracks purchases by players, wherein the database is stored on a server at the service provider's end, and duplicating a copy of the database on a server at state lottery.
6) Keep the software updated for all new games offered by the state lottery office and for new security patches.
7) Facilitate data transfer to state lottery office which is simpler than that of retailer chain model.

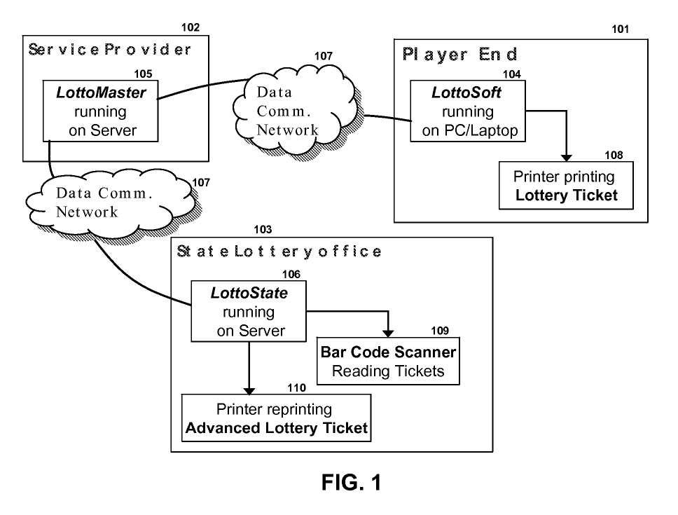

FIG. 1 illustrates an exemplary architecture for implementing a lottery playing system in accordance with the instant disclosure. The lottery game is played at player end computing device 101, which is controlled by service provider's premises computing device 102. State lottery office 103 receives data regarding each transaction to cross-check any of the numerous security measures that can be embedded into the system against any winnings claimed by a player.

The disclosed lottery play system can be seen as essentially consisting of three software modules, with one software module running at each of the three premises. A first software module is ‘LottoSoft’ 104, which runs on computing device 101 at the player premises. A second software module is ‘LottoMaster’105, which runs on a server or other computing device at service provider's premises 102. A third software module is ‘LottoState’ 106, which runs on a server or other computing device at a state lottery office 103. LottoSoft 104, can be used to play the offered lottery games, select numbers, or to buy and print lottery tickets. LottoMaster 105 monitors transactions recorded by LottoSoft 104 and maintains a database of every transaction and/or play. LottoMaster 105 maintains player account balances and permits the players to add to their balance either by credit card or check. LottoState 106 receives a copy of all data regarding each transaction or play from LottoMaster 105 before the winning numbers are drawn for each game, which enables LottoState 106 to crosscheck each claim of winnings and maintain a record of each play and player account balances.

Each of the software modules can communicate over a secure data communication network, such as one employing HTTPS over Internet 107, although such communication may be performed in a serial fashion. Communication in serial fashion among these software modules means information flows from LottoSoft 104 to LottoMaster 105, and the information is then transferred to LottoState 106 from LottoMaster 105. In an embodiment, this architecture can prevent direct access between state lottery office 103 and player end computing device 101, thereby making the disclosed system more secure. Although referred to herein as singular computing devices, the architecture described herein is capable of supporting a plurality of player end computing devices, service provider servers, and/or state lottery office servers.

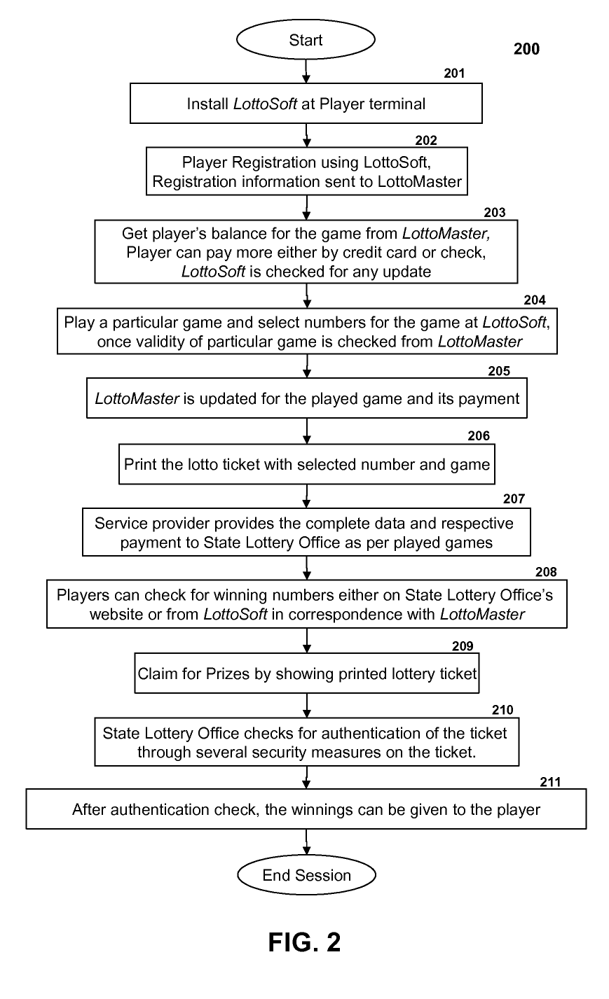

FIG. 2 is a flowchart 200 illustrating a state lottery game embodiment. When LottoMaster 105 is running on service provider computing device 102, it can monitor games played on player end computing device 101 using LottoSoft 104. If a new player wants to play a game, in accordance with step 201 of FIG. 2, the player installs LottoSoft on his PC, laptop, or other computing device. The software is remotely authenticated by the LottoMaster to ensure that the latest version is installed. Once LottoSoft is installed, the player registers himself in the lottery system using LottoSoft (step 202), and this registration information is sent to LottoMaster using a secure data communication channel. In step 203, LottoMaster manages the player's account balance, and allows the player to pay by credit card, electronic check, check mailed to the service provider, or other such means. Step 203 also includes polling LottoState and/or LottoMaster to determine if any new games are being offered by the state lottery agency, if new LottoSoft security patches are available, and performing other such administrative processes.

In step 204, a user selects numbers to be played in a particular lottery game. In an embodiment, the numbers are selected for the game using a user friendly graphical user interface provided by LottoSoft. In an embodiment, the player can be limited to playing only those games/drawings which are valid to play at the particular moment of time (i.e. the bounded time for the particular game/drawing is not over). This check is performed by LottoSoft using a secure communication channel with LottoMaster. Once the game and the numbers of a particular game have been selected, a secure communication session is established between LottoMaster and LottoSoft, during which the selected numbers and games are transmitted to LottoMaster, and the player's account balance is updated as illustrated in step 205 of FIG. 2. In step 206, the player can print a corresponding lottery ticket at his premises. The printed ticket can include several security measures, described in more detail below, to avoid any counterfeit winnings claims.

Once the bounded time for a particular game is over, the service provider's software module, LottoMaster, submits the transaction data, including respective payments based on the number of transactions for the game (step 207), to LottoState running at the state lottery office. At a certain date and time, the winning numbers for the game are drawn at state lottery office and these winning numbers are passed to LottoMaster. In accordance with step 208, the player can check for the winning number either from the official web site of the state lottery office or from LottoSoft via LottoMaster. Winners can claim their prize money by presenting a printed ticket at the state lottery office (step 209), and state lottery office authenticates the ticket using the various security measures on the ticket (step 210). After winning ticket authentication, winnings can be given to the player/owner of the claimed ticket as illustrated in step 211.

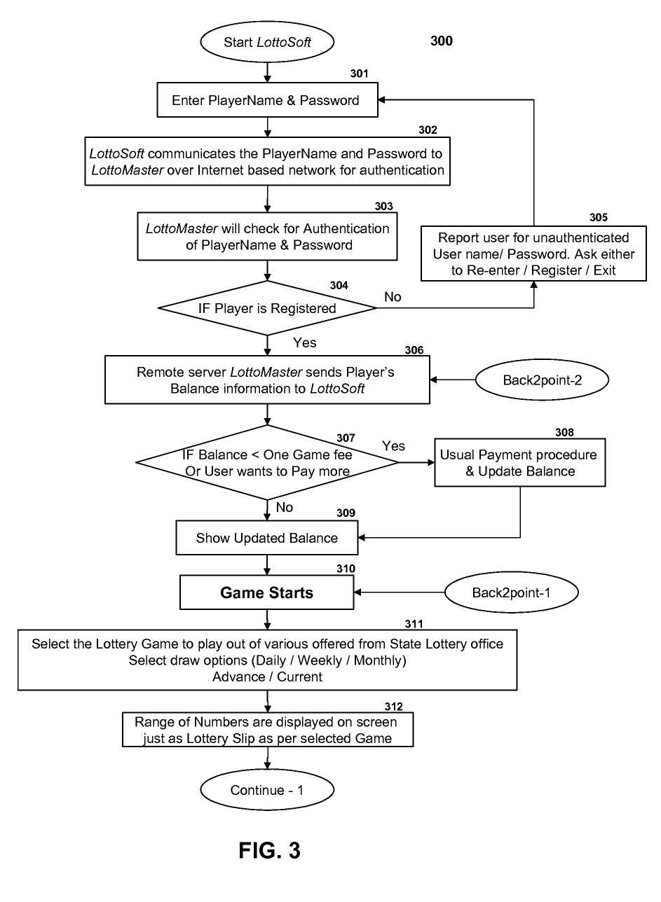

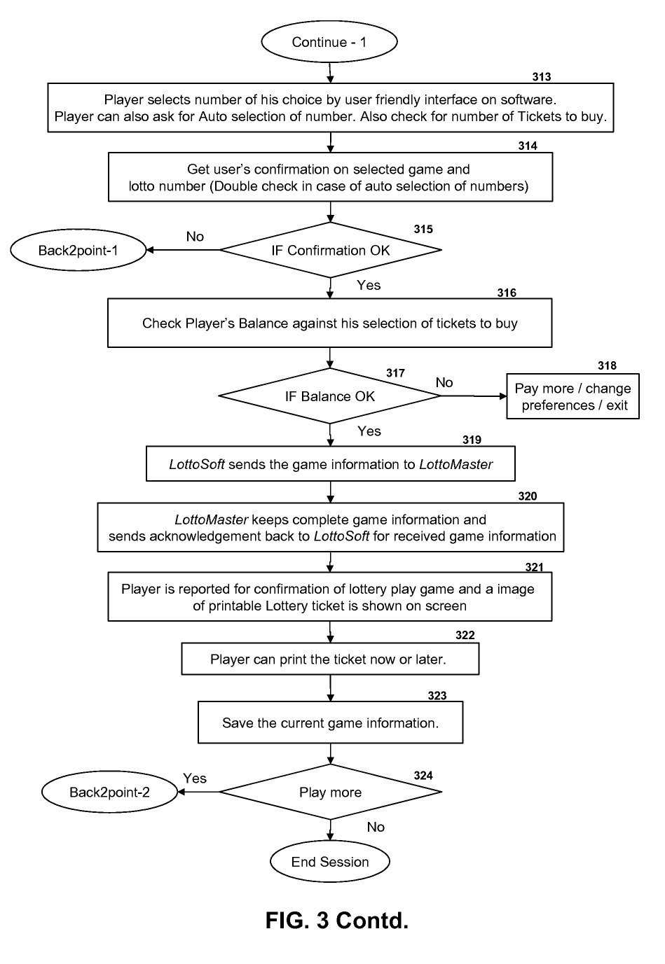

FIG. 3 is a flowchart illustrating an exemplary process 300 of playing state lottery games and buying and printing lottery tickets using LottoSoft. Once the player has installed the LottoSoft software and registered (i.e. created an account) with LottoMaster, the player is asked to enter a PlayerName and Password to log into the system, as illustrated in step 301. In step 302, LottoSoft communicates the entered PlayerName and Password to LottoMaster over a secure data communication network. In step 303, LottoMaster, running on a server at the service provider's premises, validates the PlayerName and Password from its database. In case of an unauthorized/unknown entry (step 305), LottoSoft asks the player either to login again or to exit. If the PlayerName is not registered or the Password is incorrect for the PlayerName (step 304), LottoMaster reports the unauthorized/unknown player to LottoSoft (step 305). If the PlayerName and Password match those stored in LottoMaster, then LottoMaster communicates the player's balance information to LottoSoft as illustrated in step 306. LottoMaster can ensure that every player must has a unique PlayerName.

In addition to displaying the player's account balance information to the player, LottoSoft also determines whether the balance is sufficient to play at least one game, as illustrated in step 307 of FIG. 3. If the balance is not sufficient, or if the player wishes to increase his balance, LottoSoft can permit the player to pay more at this time, as illustrated in step 308. If payment is to be made by check mailed to the service provider, the player needs to communicate the check number and other relevant information using LottoSoft. In an embodiment, the player's balance will be updated only after the service provider receives the check. However in case of credit card, electronic check, or other instantaneous or nearly instantaneous payments, the player's balance can be updated instantly. The disclosed lottery system is envisioned to adopt other payment procedures like automated funds transfers, prepaid cards, debit cards, and the like. If the balance has changed, the updated balance can be displayed for the player (step 309), and the player can begin selecting numbers for the game (step 310 of FIG. 3).

Once the number selection process starts, LottoSoft offers an option to play any of the lottery games offered by the state lottery office (step 311), and the player can select the game to be played. In the same step, the player can also choose the draw or draws in which he wishes to participate (i.e. Daily/Weekly/Monthly etc. draws). Recordation of the final game and draw selection is done after full correspondence with LottoMaster to ensure that the bounded time for the game has not expired and that the player is authenticated to play the selected game and draw. LottoSoft also allows the player to play the same numbers for future lottery games. In this case, the player needs to give his input regarding number of future games he wants to play. Thus the player will select whether he wants to play only for the current game or for future games as well the number of future games. The availability of the future play option may vary depending on the particular game selected by the player, as per state lottery office rules.

After finalization of all game-related options, the player enters into a selected game. A range of numbers associated with the game is displayed on screen as per rules of the game (step 312). In step 313, the player can select the desired number/numbers using a user friendly graphical interface presented by LottoSoft. The player can either pick the numbers of his choice manually or he can ask the software to randomly select numbers for him. LottoSoft can also ask the player for a number of tickets to be purchased with the same selected numbers for the selected game and for the same draw.

Before the selected numbers and game are finalized, the player is asked to confirm the selected game and selected numbers. This confirmation may take the form of LottoSoft explicitly displaying all of the player's selections, as illustrated in step 314. In step 315, if the player does not confirm the selected game/numbers, LottoSoft can start the game again, bringing the player back to game selection screen (i.e. step 310). After confirmation from player, LottoSoft can determine whether the player's balance is sufficient to purchase the desired tickets (step 316). If the balance is not sufficient (step 317), the insufficiency is reported to the player. In this case, the player may either pay more as per usual method of payment, change his ticket buying preferences, or exit the game (step 318). On the contrary, if the balance is sufficient to buy the selected tickets, LottoSoft communicates the relevant information to LottoMaster at remote server end at service provider's premises, (step 319).

LottoMaster can maintain all data regarding every play or other transaction and acknowledges receipt of information regarding the play to LottoSoft (step 320). In step 321, LottoSoft confirms for the player that the game has been received by LottoMaster and properly purchased. Such confirmation may occur after receiving acknowledgement from LottoMaster. LottoSoft can also display an image of one or more lottery tickets on screen for the player. The player can print the ticket(s) at that time or at any later time (step 322). LottoSoft saves the information about the game in a local data base (step 323) and the remaining player account balance is updated. If the player wishes to play more (step 324), LottoSoft brings the player back to the balance acquisition screen (step 306). If the player does not wish to play more games, the current login session for the player will be ended. Thus the disclosed method of playing lottery game while being at home/office using software has kept the basic way of playing the game intact while making it more automatic, user friendly and convenient by avoiding visits to a retail store each time the player wishes to play.

Once the bounded time for a particular game is over (i.e. before drawing of winning numbers for a particular game), LottoState requests the complete data regarding each play for the game from LottoMaster. LottoMaster transfers the requested data to LottoState over a secure data communication network. This process not only makes all data available to the state lottery office before any drawing so the state lottery office can securely handle any claims of winnings, but also makes the disclosed system secure against an intruder who attempts to purchase a ticket for a game whose winning numbers are already declared. This process protects against such a nefarious intruder because, once the data regarding any game has been forwarded to LottoState, LottoMaster does not allow players to add to the plays associated with that game and none of the players has access to state lottery office server. Once the winning numbers are drawn, the winning numbers are sent to LottoMaster so that LottoSoft users can check for winning numbers using LottoSoft via LottoMaster.

After declaring winning numbers and gathering the relevant data from LottoMaster, the state lottery office is ready to handle any claims for winnings for the game with the help of LottoState. In an embodiment, LottoState has an interface with bar code reader 109, as shown in FIG. 1, to read a bar code printed on the ticket. LottoState decodes the read code using a secure algorithm and keys which are only available with LottoState, and generates the relevant information. The information is first checked against the printed information on the ticket, to confirm that player has not altered the printed numbers. LottoState can also cross-check the same information with data collected from LottoMaster to provide added security. Once all the information is validated and the printed ticket is authenticated, the winnings can be paid to the owner.

A special provision is provided at LottoState to handle advanced play tickets. Whenever a player claims winnings with a ticket which is valid for future games as well, the player receives a special re-printed ticket in exchange for the submitted ticket. The State lottery office prints such a special ticket using LottoState and printer 110, as illustrated in FIG. 1. The re-printed ticket is valid for future games.

Thus, the disclosed system and method to play lottery games, and to buy and print lottery tickets from home/office using software running on PC/Laptop not only gives a very convenient alternative to visiting retail stores each time a player wishes to play a lottery game but also simplifies the process chain of the game. The disclosed system and method incorporates numerous security measures to assure a secure game. In accordance with the instant disclosure, the security measures embedded into the disclosed system and method include, but are not limited to:
Even though a lottery game is played using software on a player computing device, the player can obtain a printed lottery ticket. This equates to current security level of printed lottery ticket.
Lottery tickets printed using LottoSoft have not only the numbers chosen by the player for a particular game but can also include other information, including, without limitation, game type, player's user id, LottoSoft software authentication id, time and date of play, amount paid, and the like printed on it. This makes the printed lottery ticket itself less vulnerable to attack or counterfeiting.
The printed lottery ticket may also have an encoded bar code printed on it containing all the information and/or a transaction id which serves as a pointer to the corresponding information stored in the LottoMaster and/or LottoState database. Complementary reading and decoding of this bar code can only be done at state lottery office using LottoState interfaced with a bar code reader. The decoding of the bar code can use secure algorithms and keys.
LottoSoft allows only one time printing of a ticket for a play. No duplication of lottery tickets is allowed. Loss of a printed ticket will be responsibility of the player, as is the case in the current retail system.
Before a player is allowed to select numbers for a selected game and drawing, LottoSoft seeks permission from LottoMaster. Thus LottoMaster can monitor each play as well as allowing a player to play only for those games for which time, player's account balance and other such factors permit.
LottoMaster keeps a record of each play and also maintains player's account balance.
LottoState receives all records corresponding to every play for a particular game before the bounded time is over. Once data transfer to LottoState has been initiated, play for the particular game is halted, and LottoMaster will not accept new plays from LottoSoft.
Multiple backups of all the data at the service provider's server and the state lottery office, along with printed hard copies of all data at both locations, gives full assurance against any system failure.
Communication between LottoSoft and LottoMaster and between LottoMaster and LottoState are made using secure data communication protocols with numerous security features taken into account such as, without limitation, digital signatures, firewalls, encryption, and the like.
In an embodiment, the server at the state lottery office is not kept on open web access; only a secure communication link with service provider's server is used.

The instant disclosure provides a system and method of playing lottery games, and for buying and printing lottery tickets from a home/office using PC, laptop or other computing device on which appropriate software has been installed. Through this software, the player can purchase as mange game plays as he/she wishes. Numerous security measures are also embedded into the system to ensure accurate game play. Software at a service provider's premises monitors every play for all the games played at player ends and maintains a player's balance to play lottery games. The disclosed systems and methods simplifies the process chain of lottery games by eliminating thousands of retailers from the chain. Software at a state lottery office receives a copy of all the records to securely handle claims for winnings.

While the invention has been particularly explained with reference to a preferred software implementation, it will be understood by those skilled in the art that various changes in form and detail may be made therein without departing from the spirit and scope of the invention.

What is claimed is:

1. A system for enabling state lottery game play, comprising:
a first software module, wherein the first software module stores player account information and validates state lottery game play purchase information;
a second software module, wherein the second software module runs on a player computing device, wherein the second software module facilitates a player authenticating himself with the first software module, wherein the first software module and the second software module communicate only player authentication information, user account information, player lottery game play purchase information, and player registration information, wherein the second software module facilitates selection of numbers to be played in a lottery game, and wherein the second software module facilitates the printing of lottery tickets; and,
a third software module, wherein the third software module receives lottery game play purchase data from the first software module, and wherein the third software module transmits winning game information to the second software module.

2. The system of claim 1, wherein the player computing device is at a player premises.

3. The system of claim 1, wherein the player computing device is a computer.

4. The system of claim 1, wherein the player computing device is a cellular telephone.

5. The system of claim 1, wherein the player computing device is a portable digital assistant.

6. The system of claim 1, wherein the first secure data communication network and the second secure data communication network are isolated such that the second software module and the third software module cannot communicate with each other.

7. The system of claim 1, wherein the lottery tickets printed using the second software module include a machine readable code.

8. The system of claim 7, wherein the machine readable code is a bar code.

9. The system of claim 1, wherein the lottery tickets printed using the second software module include a player identifier.

10. The system of claim 9, wherein the player identifier is a username assigned to the player.

11. The system of claim 9, wherein the player identifier is an account number associated with the player.

12. The system of claim 9, wherein the player identifier is incorporated into a machine readable code.

13. The system of claim 1, wherein each lottery ticket printed using the second software module includes identification information comprising a game type identifier, a player identifier, an authentication identifier associated with the second software module, a date and time stamp, and an indicator of the amount paid when purchasing the ticket.

14. The system of claim 13, wherein the identification information is also incorporated into a machine readable code.

15. The system of claim 1, wherein the game play purchase information comprises an authentication that the bounded time associated with a game to which the game play purchase information corresponds has not expired.

16. The system of claim 16, wherein the first software module will not accept game play purchase information for games for which the bounded time associated with the game has expired.

17. The system of claim 1, further comprising:
a first secure data communication network, wherein the first secure data communication network facilitates communication between the first software module and the second software module; and,
a second secure data communication network, wherein the second secure data communication network facilitates communication between the first software module and the third software module.

18. The system of claim 1, wherein the first software module runs on a server at a service provider premises.

19. The system of claim 1, wherein the third software module runs on a server at a state lottery office.

20. A method of playing a state lottery game, comprising:
receiving first data at a first software module data from a second software module, wherein the first data comprises player authentication information, and wherein the second software module is running on a player computing device;
validating the first data against player information stored at the second software module;
exiting the method or repeating the receiving of the first data in the event the player information is invalid;
transmitting player account information to the second software module;
receiving second data by the first software module from the second software module, wherein the second data comprises game play information;
storing the second data in the first software module;
transmitting the game play information to a third software module;
receiving game result information from the third software module; and,
using the third software module to validate claims for winning lottery games.

21. The method of claim 20, wherein the third software module validates claims for winning lottery games by scanning machine readable information from a printed ticket, wherein the ticket has been printed by the second software module.

22. The method of claim 20, further comprising determining a version associated with the second software module and, where the version is not a current version, forcing the second software module to be updated to the current version.

23. The method of claim 20, wherein communications between the first software module and the second software module are facilitated via a first secure communications means, and wherein communications between the first software module and the third software module are facilitated via a second secure communications means.

24. The method of claim 23, wherein the first secure communications means is isolated from the second communications means, such that the second software module and the third software module cannot directly communicate.

25. The method of claim 20, wherein the second software module and the third software module cannot directly communicate.

26. The method of claim 20, wherein the first software module is running on a service provider server.

27. The method of claim 20, wherein the third software module is running on a server at a state lottery premises.

28. A system for enabling state lottery game play, comprising:
a first software module, wherein the first software module stores player account information;
a second software module, wherein the second software module runs on a player computing device, wherein the second software module facilitates a player authenticating himself with the first software module, wherein the first software module and the second software module communicate only player authentication information, user account information, player lottery game play purchase information, and player registration information, wherein the second software module facilitates selection of numbers to be played in a lottery game, and wherein the second software module facilitates the printing of lottery tickets; and,
wherein the first software module validates state lottery game play purchase information, wherein the first software module receives lottery game play purchase data from the second software module, and wherein the first software module transmits winning game information to the second software module.
